(19) United States
(12) Patent Application Publication
(10) Pub. No.: US 2010/0177130 A1
(43) Pub. Date: Jul. 15, 2010

(54) APPARATUS AND METHOD FOR ADJUSTING DEFINITION

(76) Inventor: Wei-Hsiang SHEN, Taipei (TW)

Correspondence Address: Muncy, Geissler, Olds & Lowe, PLLC, 4000 Legato Road, Suite 310, FAIRFAX, VA, 22033, US

(21) Appl. No.: 12/467,781

(22) Filed: May 18, 2009

(30) Foreign Application Priority Data
Jan. 15, 2009 (TW) 98101439

(51) Int. Cl. G09G 5/02

(52) U.S. Cl. 345/698

(57) ABSTRACT

In the specification and drawing an apparatus for adjusting definition is disclosed. The apparatus can separate the first set of pulses from the second set of pulses and modulate distinct definition signals. Moreover, a method for adjusting definition is also disclosed in specification and drawing.

### RELATED APPLICATIONS

This application claims priority to Taiwan Application Serial Number 98101439, filed Jan. 15, 2009, which is herein incorporated by reference.

### BACKGROUND

1. Field of Invention

The present invention relates to an electronic device. More particularly, the present invention relates to an apparatus and a method for adjusting definition.

2. Description of Related Art

In general, a source inputs an image signal to a display, and then the display can show image according to the image signal. Thus, users watch frames showed in the display.

Nowadays, the image signal is mostly processed by software, including two steps: the image signal is temporarily stored, and then the entire image is adjusted according to the image signal. Therefore, software cannot immediately process the image signal; moreover, if the image has a small object and a large object, the small and large objects only appear a common picture quality.

In view of above, there is a need in the related field to provide an apparatus and a method for adjusting definition for the sake of varied objects.

### SUMMARY

The following presents a simplified summary of the invention in order to provide a basic understanding to the reader. This summary is not an extensive overview of the invention and it does not identify key/critical elements of the present invention or delineate the scope of the present invention. Its sole purpose is to present some concepts disclosed herein in a simplified form as a prelude to the more detailed description that is presented later.

In one or more aspects, the present invention is directed to an apparatus and a method for adjusting definition for the sake of varied objects.

In accordance with another embodiment of the present invention, the apparatus for adjusting definition comprises a signal buffer circuit, an object identification circuit, a voltage converter and an enhanced definition circuit. The signal buffer circuit can acquire an image signal from a source, wherein the image signal comprise at least one first set of pulses and at least one second set of pulses, wherein the pulse number of the first set of pulses is more than the pulse number of the second set of pulses. The object identification circuit can transform the first set of pulses into a first object signal and transform the second set of pulses into a second object signal, wherein a voltage of the first object signal is greater than a voltage of the second object signal. The voltage converter can increase the voltage of the first object signal and the voltage of the second object signal. The enhanced definition circuit can discriminate the first set of pulses from the second set of pulses in the image signal in accordance with the increased voltage of the first object signal and the increased voltage of the second object signal to convert the first set of pulses into at least one first definition signal and to convert the second set of pulses into at least one second definition signal.

Accordingly, the apparatus can immediately separate the first set of pulses of the small object from the second set of pulses of the large object and modulate distinct definition signals.

In accordance with an embodiment of the present invention, the method for adjusting definition comprises the following steps:

(1) An image signal is acquired from a source, wherein the image signal comprise at least one first set of pulses and at least one second set of pulses, wherein the pulse number of the first set of pulses is more than the pulse number of the second set of pulses;

(2) The first set of pulses are transformed into a first object signal and the second set of pulses are transformed into a second object signal, wherein a voltage of the first object signal is greater than a voltage of the second object signal;

(3) The voltage of the first object signal and the voltage of the second object signal are increased; and

(4) In the image signal the first set of pulses are discriminated from the second set of pulses in accordance with the increased voltage of the first object signal and the increased voltage of the second object signal to convert the first set of pulses into at least one first definition signal and to convert the second set of pulses into at least one second definition signal.

Accordingly, the method is performed to immediately separate the first set of pulses of the small object from the second set of pulses of the large object and to modulate distinct definition signals.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a block diagram of an apparatus for adjusting definition according to an embodiment of the present invention;

FIG. 2 illustrates function of the object identification circuit of FIG. 1;

FIG. 3 is a circuit diagram of the apparatus 100 of FIG. 1;

FIG. 4 shows two capture images; and

FIG. 5 shows a flow chart of a method for processing video according to another embodiment of the present invention.

Like reference numerals are used to designate like parts in the accompanying drawings.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein, the term “and/or” includes any and all combinations of one or more of the associated listed items.

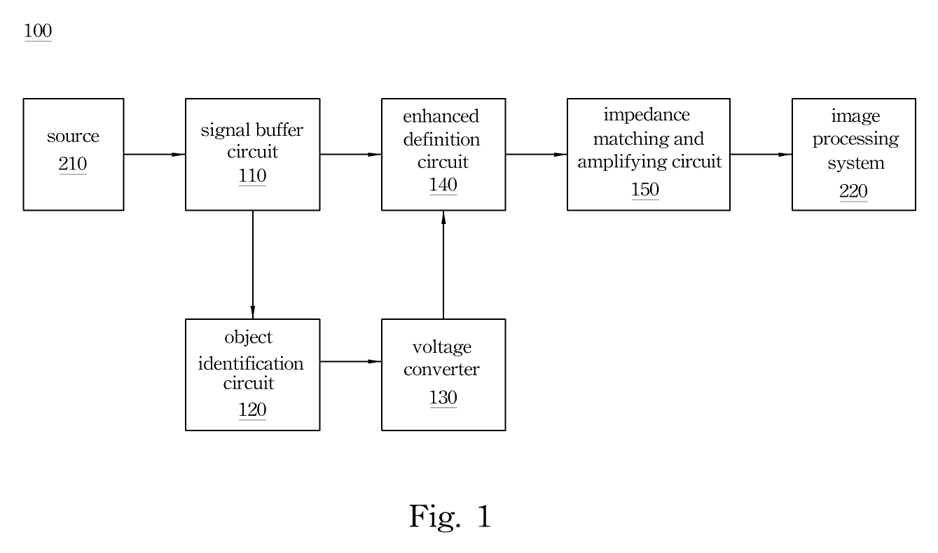

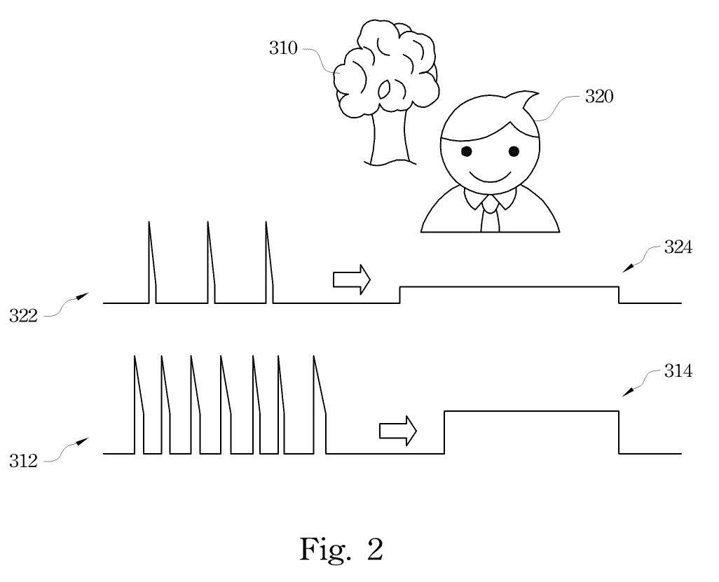

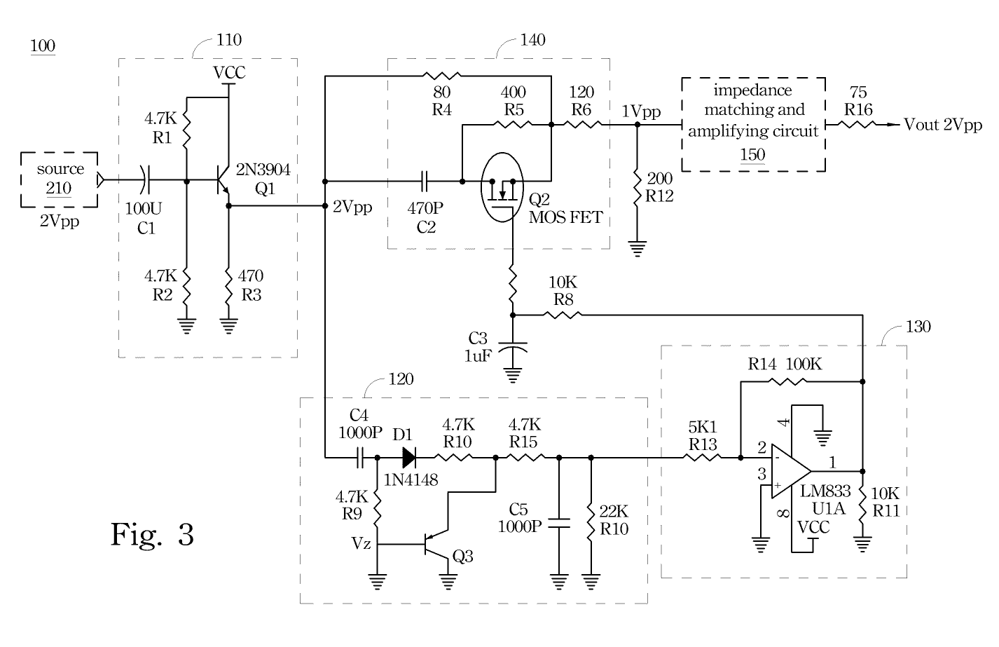

One aspect of the present invention is directed to an apparatus for adjusting definition. The apparatus may be easily inserted into a display and may be applicable or readily adaptable to all technologies. Herewith the apparatus for adjusting definition is illustrated by reference to the following description considered in FIG. 1, FIG. 2 and FIG. 3.

Please refer to FIG. 1. FIG. 1 is a block diagram of an apparatus 100 for adjusting definition according to an embodiment of the present invention. In FIG. 1, the apparatus 100 is electrically connected to the source 210.

The source 210 can provide an image signal. The image signal comprises at least one first set of pulses and at least one second set of pulses. The first set of pulses represents a small object of an image, such as a tree, a mountain, grassland or the like; the second set of pulses represents a large object of an image, such as a person, a house, a car or the like. In the image the small object is shaped by first outlines, and the large object is shaped by second outlines, wherein the number of the first outlines of the small object is more than the number of the second outlines of the large object. Therefore, the pulse number of the first set of pulses is more than the pulse number of the second set of pulses.

In practice, the source 210 may be a DVD player or output terminals of a signal generator, so as to output the image signal. One of ordinary skill in the art will appreciate that the above examples are provided for illustrative purposes only to further explain applications of the present invention and are not meant to limit the present invention in any manner. Another device, such as a hardware circuitry or the like, may be used as appropriate for a given application.

The apparatus 100 can immediately separate the first set of pulses of the small object from the second set of pulses of the large object for image processing. In FIG. 1, the apparatus 100 comprises a signal buffer circuit 110, is an object identification circuit 120, a voltage converter 130 and an enhanced definition circuit 140.

The signal buffer circuit 110 is electrically connected to the source 210. The signal buffer circuit 110 is electrically connected to the object identification circuit 120. The object identification circuit 120 is electrically connected to the voltage converter 130. The voltage converter 130 is electrically connected to the enhanced definition circuit 140. The enhanced definition circuit 140 is electrically connected to the signal buffer circuit 110.

The signal buffer circuit 110 can acquire an image signal from a source 210, wherein the image signal comprises at least one first set of pulses and at least one second set of pulses, wherein the pulse number of the first set of pulses is more than the pulse number of the second set of pulses. The object identification circuit 120 can transform the first set of pulses into a first object signal and transform the second set of pulses into a second object signal, wherein a voltage of the first object signal is greater than a voltage of the second object signal. The voltage converter 130 can increase the voltage of the first object signal and the voltage of the second object signal. The enhanced definition circuit 140 can discriminate the first set of pulses from the second set of pulses in the image signal in accordance with the increased voltage of the first object signal and the increased voltage of the second object signal to convert the first set of pulses into at least one first definition signal and to convert the second set of pulses into at least one second definition signal.

Accordingly, the apparatus 100 can immediately separate the first set of pulses of the small object from the second set of pulses of the large object and modulate distinct definition signals.

In FIG. 1, the apparatus 100 comprises an impedance matching and amplifying circuit 150. The enhanced definition circuit 140 is electrically coupled to the image processing system 220 via the impedance matching and amplifying circuit 150. The impedance matching and amplifying circuit 150 can input the first definition signal and the second definition signal to an image processing system 220, and the image processing system 200 responds to the impedance matching and amplifying circuit 150 for adjusting definition of a first object of an image according to the first definition signal and adjusting definition of a second object of the image according to the second definition signal, wherein the definition of the first object is greater than the definition of the second object.

Accordingly, the apparatus 100 can modulate two distinct definition signals for the small object and the large object respectively. Therefore, the image processing system 220 can adjust the definition of the small object and the definition of the large object respectively, wherein the definition of the first object is greater than the definition of the second object.

The image processing system 220 may be integrated into the apparatus 100; alternatively, the image processing system 220 may be an external device. For example, the image processing system 220 is employed in a display, a television or the like. One of ordinary skill in the art will appreciate that the above examples are provided for illustrative purposes only to further explain applications of the present invention and are not meant to limit the present invention in any manner. Another device, such as a monitor, may be used as appropriate for a given application.

Please refer to FIG. 2. FIG. 2 illustrates the function of the object identification circuit of FIG. 1. In FIG. 2, an image comprises a small object 310 and a large object 320, wherein the number of the outlines of the small object 310 is more than the number of the outlines of the large object 320. An image signal corresponding to the image comprises a first set of pulses 312 and a second set of pulses 322, wherein the first set of pulses 312 represents a small object 310 of an image, and the second set of pulses 322 represents a large object 320 of an image. Correspondingly, the pulse number of the first set of pulses 312 is more than the pulse number of the second set of pulses 322.

The above object identification circuit can transform the first set of pulses 312 into a first object signal 314 and transform the second set of pulses 322 into a second object signal 324, wherein a voltage of the first object signal 314 is greater than a voltage of the second object signal 324.

For a more complete understanding of the apparatus 100, please refer to FIG. 3. FIG. 3 is a circuit diagram of the apparatus 100 of FIG. 1. In FIG. 1, the signal buffer circuit 110 comprises an emitter follower. The emitter follower comprises a capacitor C1, resistors R1, R2, R3 and a bipolar transistor Q1. The emitter follower is electrically connected to the source 210. In general the source 210 can output an image signal, wherein the voltage level of the image signal is 2 Vpp; the emitter follower acts as a constant voltage source to amplify an electric current of the image signal and then sends the image signal to the object identification circuit 120 and the enhanced definition circuit 140.

The object identification circuit 120 comprises a differentiator, a damper and an integrator. The differentiator comprises a capacitor C4 and a resistor R9. The damper comprises a resistor R10, a bipolar transistor Q3 and a diode D1. The integrator comprises the capacitor C5 with the resistor R10 or a resistor R15. The above emitter follower is electrically connected to the differentiator; the differentiator is electrically connected to the clamper; the damper is electrically connected to the integrator. The differentiator can derive the first set of pulses and the second set of pulses from the image signal; the damper can adapt the first set of pulses and the second set of pulses to the integrator; the integrator can integrate the first set of pulses into the first object signal and integrate the second set of pulses into the second object signal.

The voltage converter 130 comprises an operational amplifier. The model of the operational amplifier is U1A LM833. The operational amplifier is electrically connected to the above differentiator. The operational amplifier can receive the first object signal and the second object signal from the differentiator and increase the voltage of the first object signal and the voltage of the second object signal because the voltage of the first object signal and the voltage of the second object signal form the differentiator are weak.

The enhanced definition circuit 140 comprises an analog switch and a differentiating circuit. The analog switch comprises a metal oxide semiconductor field effect transistor (MOS) Q2. The differentiating circuit comprises a capacitor C2 and resistors R4, R5, R6. The analog switch is electrically connected to the above operational amplifier; the differentiating circuit is electrically connected to the above emitter follower; the analog switch is electrically connected to the differentiating circuit. The analog switch is turned on whenever receiving the increased voltage of the first object signal, and the analog switch is turned off whenever receiving the increased voltage of the second object signal. The differentiating circuit can convert the first set of pulses into the first definition signal when the analog switch is turned on and convert the second set of pulses into the second definition signal when is turned off. Accordingly, the enhanced definition circuit 140 can acquire the image signal from the signal buffer circuit 110 and get the first object signal and the second object signal form from the voltage converter 130 for converting the first set of pulses of the image signal into the first definition signal whenever receiving the increased voltage of the first object signal and converting the second set of pulses of the image signal into the second definition signal whenever receiving the increased voltage of the second object signal. In FIG. 3, the MOS Q2 is turned on/off in accordance with the first object signal /the second object signal, for modulating impedance comprised of the resistors R4, R5, R6 served to control differential gap of the differentiating circuit. The MOS Q2 is turned on when the voltage converter 130 inputs the first object signal; therefore, the differentiating circuit can convert the first set of pulses of the image signal into the first definition signal when the MOS Q2 is turned on and drop the voltage level of the first definition signal to 1 Vpp. On the contrary, the MOS Q2 is turned off when the voltage converter 130 inputs the second object signal; therefore, the differentiating circuit can convert the second set of pulses of the image signal into the second definition signal when the MOS Q2 is turned off and drop the voltage level of the second definition signal to 1 Vpp. Moreover, the impedance matching and amplifying circuit 150 can amplify the voltage level of the first definition signal and the voltage level of the second definition signal to 2 Vpp.

In view of all of the above and the Figures, the apparatus 100 can automatically modulate the definition of outlines in accordance with the image signal in order to display frame with high contrast. Moreover, the apparatus 100 belongs to analog circuits so as to adjust definition immediately.

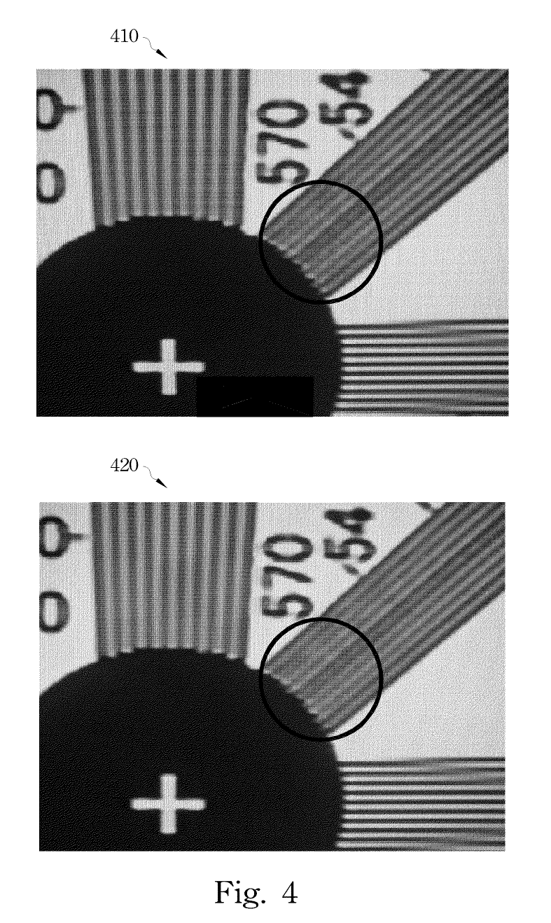

Please refer to FIG. 4. FIG. 4 shows two capture images. The image 410 is processed by means of the apparatus 100; the image 420 is not processed by means of the apparatus 100. The small object of the image 410 is circled, and the small object of the image 420 is also circled. Comparatively, the definition of small object of the image 410 is greater than the definition of small object of the image 420.

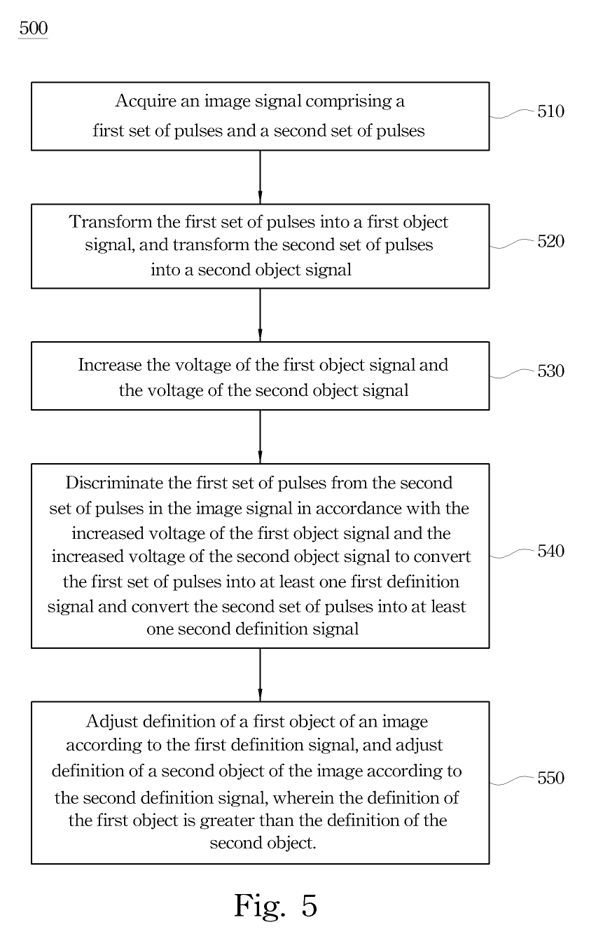

Another aspect of the present invention is directed to a method for adjusting definition. The method may be easily inserted into a display and may be applicable or readily adaptable to all technologies. Herewith the method for adjusting definition is illustrated by reference to the following description considered in FIG. 5.

Please refer to FIG. 5. FIG. 5 shows a flow chart of a method 500 for processing video according to another embodiment of the present invention. The method 500 at least comprises step 510, step 520, step 530 and step 540. In the method 500, it should be noted that one step might be performed in series, in parallel, in combination, or otherwise in conjunction with another if the specific order is not described or inferred in the embodiment.

In step 510, an image signal is acquired from a source, wherein the image signal comprises at least one first set of pulses and at least one second set of pulses, wherein the pulse number of the first set of pulses is more than the pulse number of the second set of pulses.

In step 520, the first set of pulses are transformed into a first object signal and the second set of pulses are transformed into a second object signal, wherein a voltage of the first object signal is greater than a voltage of the second object signal;

In step 530, the voltage of the first object signal and the voltage of the second object signal are increased; and

In step 540, in the image signal the first set of pulses are discriminated from the second set of pulses in accordance with the increased voltage of the first object signal and the increased voltage of the second object signal to convert the first set of pulses into at least one first definition signal and to convert the second set of pulses into at least one second definition signal.

Accordingly, the method 500 is performed to immediately separate the first set of pulses of the small object from the second set of pulses of the large object and to modulate distinct definition signals.

Furthermore, during step 540, the first set of pulses of the image signal is converted into the first definition signal whenever receiving the increased voltage of the first object signal. Additionally or alternatively, during step 540, the second set of pulses of the image signal is converted into the second definition signal whenever receiving the increased voltage of the second object signal is received.

In FIG. 5, the method 500 comprises step 550. In step 550, definition of a first object of an image is adjusted according to the first definition signal, and definition of a second object of the image is adjusted according to the second definition signal, wherein the definition of the first object is greater than the definition of the second object.

Accordingly, the method 500 is performed to modulate two distinct definition signals for the small object and the large object respectively, and then the definition of the small object the definition of the large object are adjusted respectively, wherein the definition of the first object is greater than the definition of the second object.

The foregoing outlines features of several embodiments so that those skilled in the art may better understand the aspects of the present invention. Those skilled in the art should appreciate that they may readily use the present invention as a basis for designing or modifying other processes and structures for carrying out the same purposes and/or achieving the same advantages of the embodiments introduced herein. Those skilled in the art should also realize that such equivalent constructions do not depart from the spirit and scope of the present invention, and that they may make various changes, substitutions and alterations herein without departing from the spirit and scope of the present invention.

What is claimed is:

1. An apparatus for adjusting definition, comprising:
means for acquiring an image signal from a source, wherein the image signal comprises at least one first set of pulses and at least one second set of pulses, wherein the pulse number of the first set of pulses is more than the pulse number of the second set of pulses;
means for transforming the first set of pulses into a first object signal and transforming the second set of pulses into a second object signal, wherein a voltage of the first object signal is greater than a voltage of the second object signal;
means for increasing the voltage of the first object signal and the voltage of the second object signal; and
means for discriminating the first set of pulses from the second set of pulses in the image signal in accordance with the increased voltage of the first object signal and the increased voltage of the second object signal to convert the first set of pulses into at least one first definition signal and to convert the second set of pulses into at least one second definition signal.

2. The apparatus as claimed in claim 1, further comprising:
means for inputting the first definition signal and the second definition signal to an image processing system, wherein the image processing system responds to the inputting means for adjusting definition of a first object of an image according to the first definition signal and adjusting definition of a second object of the image according to the second definition signal, wherein the definition of the first object is greater than the definition of the second object.

3. The apparatus as claimed in claim 1, wherein the acquiring means comprises an emitter follower electrically connected to the source.

4. The apparatus as claimed in claim 1, wherein the transforming means comprises:
a differentiator electrically connected to the emitter follower;
a damper electrically connected to the differentiator; and
an integrator electrically connected to the clamper.

5. The apparatus as claimed in claim 1, wherein the increasing means comprises:
an operational amplifier electrically connected to the integrator.

6. The apparatus as claimed in claim 1, wherein the discriminating means comprises:
an analog switch electrically connected to the operational amplifier; and
a differentiating circuit electrically connected to the emitter follower and the analog switch.

7. The apparatus as claimed in claim 1, wherein the discriminating means comprises:
an analog switch, wherein the analog switch is turned on whenever receiving the increased voltage of the first object signal, and the analog switch is turned off whenever receiving the increased voltage of the second object signal; and
means for converting the first set of pulses into the first definition signal when the analog switch is turned on and converting the second set of pulses into the second definition signal when is turned off.

8. A method for adjusting definition, comprising:
(a) acquiring an image signal from a source, wherein the image signal comprises at least one first set of pulses and at least one second set of pulses, wherein the pulse number of the first set of pulses is more than the pulse number of the second set of pulses;
(b) transforming the first set of pulses into a first object signal and transforming the second set of pulses into a second object signal, wherein a voltage of the first object signal is greater than a voltage of the second object signal;
(c) increasing the voltage of the first object signal and the voltage of the second object signal; and
(d) discriminating the first set of pulses from the second set of pulses in the image signal in accordance with the increased voltage of the first object signal and the increased voltage of the second object signal to convert the first set of pulses into at least one first definition signal and to convert the second set of pulses into at least one second definition signal.

9. The method as claimed in claim 7, further comprising:
adjusting definition of a first object of an image according to the first definition signal; and
adjusting definition of a second object of the image according to the second definition signal, wherein the definition of the first object is greater than the definition of the second object.

10. The method as claimed in claim 7, wherein the step (d) comprises:
converting the first set of pulses of the image signal into the first definition signal whenever receiving the increased voltage of the first object signal; and
converting the second set of pulses of the image signal into the second definition signal whenever receiving the increased voltage of the second object signal is received.
